(19) United States
(12) Patent Application Publication
(10) Pub. No.: US 2014/0260844 A1
(43) Pub. Date: Sep. 18, 2014

(54) APPARATUS AND METHOD FOR CUTTING HAIR

(71) Applicant: Raisa Raskin, Tempe, AZ (US)

(72) Inventor: Raisa Raskin, Tempe, AZ (US)

(21) Appl. No.: 13/829,189

(22) Filed: Mar. 14, 2013

(51) Int. Cl. B26B 19/38

(52) U.S. Cl. CPC B26B 19/3806
USPC 83/13; 30/196

(57) ABSTRACT

The invention discloses for one or more combs, where the spine thickness of a given comb is specifically matched to the thickness of a cutting blade for an electric clipper and used to more effectively and efficiently select the proper combination of cutting blade and comb for trimming and blending hair. In addition, a method of using the combs to make a smoother and more even transition from one hair length to another hair length in the hair-cutting process is also disclosed.

### RELATED APPLICATION

This patent application is a continuation-in-part of U.S. patent application Ser. No. 12/843,865, which application was filed on 26 Jul. 2010 and which application is presently pending and which application is incorporated herein by reference.

### BACKGROUND OF THE INVENTION

1. Technical Field

The present invention generally relates to hair styling and relates more specifically to implements used in conjunction with electric clippers.

2. Background Art

Cutting hair is a skill and an art, much more than a science. Although the standard implements used in cutting hair are well known, it is the skill of the barber or the stylist that determines the quality of a haircut. It can take many years to learn how to cut hair and, in the early stages of a career, mistakes and bad haircuts are not uncommon.

Even with the most skilled stylists and barbers, it is possible to make a mistake in the haircutting process, thereby creating a “bad hair day” for the customer. One of the most common mistakes, especially when using electric hair clippers, is a tendency to cut a portion of the hair too short, thereby creating a need to “fix” the problem. This typically results in a haircut that is noticeably shorter than originally planned, if the problem can be fixed at all. Accordingly, most new graduates of hair styling and barber schools work for years trying to develop the necessary skills that are needed to be a successful stylist or barber.

In general, most haircutting professionals establish a “guide” length, which is the desired length that the customer specified for the hair on the sides & back of the head. For example, several of the most common blades that are used to achieve a desired length for many haircuts are the Oster® #1.5 blade (˜4.5 mm or 5/32″) and the Oster® #2 blade (˜6 mm or ¼″). The number of the blade correlates generally to the length that the hair should be cut to on the sides and back of the head. The desired length for the hair on the top of the head is generally specified by the customer in inches (e.g., ½″ or 1″). Given this, the art of the haircutting profession includes the ability to make the transition from length of the hair on the sides and back of the head (guide length) to the top length in a smooth and precise fashion.

For most barbers and hair stylists, this transition in the length of the hair is accomplished by using a standard comb in a “freestyle” manner. To make the transition, the barber or hairstylist will typically hold the comb in one hand and use the comb to lift the hair away from the head. Then, they will cut the hair with the other hand using an electric hair clipper with the selected blade attachment. In order to achieve a smooth transition between two different lengths of hair, the barber or stylist needs to hold the hand with the comb in the air without any support and estimate or “eye ball” the length of hair to be cut. In this stage of the haircut it is very easy to make a mistake and cut the hair too close to the scalp (i.e. shorter than the guide length). Once the hair is cut too short in one spot, it cannot be fixed except by cutting the hair shorter all around the head. This stage of the haircut requires very precise hand-eye coordination and can be a very challenging operation that requires high concentration and precision. Many barbers and hair stylists, both new and experienced, find it difficult to make the transition between the different lengths of hair, resulting in uneven and unprofessional haircuts. Accordingly, without improvements in the implements and methods of cutting hair, the process and results of many haircuts will continue to be sub-optimal.

### BRIEF SUMMARY OF THE INVENTION

A specialized set of combs, comprising a plurality of combs with varying spine thicknesses that are specifically calibrated to the thickness of the plate for an electric clipper blade is disclosed. In addition, a method of using the combs in the hair-cutting process is disclosed. By selecting a comb with a spine thickness that matches the blade plate, the desired hair length can be achieved with a reduced probability of accidentally cutting the hair too short.

### BRIEF DESCRIPTION OF THE FIGURES

The preferred embodiments of the present invention will hereinafter be described in conjunction with the appended drawings, wherein like designations denote like elements, and:

FIG. 1 is an illustration of a hair cutting tool used in conjunction with a preferred exemplary embodiment of the present invention;

FIGS. 2A and 2B illustrate a pair of removable clipper blades commonly used in conjunction with electric clippers when cutting hair;

FIGS. 3A and 3B are side views of the clipper blades of FIG. 2A and FIG. 2b;

FIG. 4A and FIG. 4B illustrate a pair of combs suitable for use in conjunction with a preferred embodiment of the present invention;

FIGS. 5A and 5B are top views of the combs of FIGS. 4A and 4B; and

FIG. 6 illustrates a method of using the combs of the present invention to provide a haircut to a customer in accordance with a preferred embodiment of the present invention.

### DETAILED DESCRIPTION

A specialized set of combs, comprising a plurality of combs with varying spine thicknesses that are specifically calibrated to the thickness of the plate for an electric clipper is disclosed. In addition, a method of using the combs in the hair-cutting process is disclosed. By selecting a comb with a spine thickness that matches the blade plate, the desired hair length can be achieved with a reduced probability of accidentally cutting the hair too short.

Referring now to FIG. 1, an electric clipper 110, suitable for use in conjunction with a preferred exemplary embodiment of the present invention is depicted. Electric clipper 110 has a body portion 111 for holding electric clipper 110 and is configured with the capability to selectively detachable clipper blade at clipper head 112. The clipper blades of FIG. 2A and FIG. 2B may be used interchangeably with electric clipper 110.

Referring now to FIGS. 2A and 2B, a clipper blade 210 and a clipper blade 220 suitable for use in conjunction with a preferred exemplary embodiment of the present invention are depicted. These clipper blades are representative of a series of clipper blades that may be attached to electric clipper 110 of FIG. 1. In the most preferred embodiments of the present invention, each of clipper blade 210 and clipper blade 220 has a numeric indicia stamped or embossed into the body of the clipper blade. Different clipper blades are used to cut hair, with the appropriate clipper blade being selected to correspond to the thickness of the spine of a comb. The appropriate combination will be determined by the desired amount of hair to be cut and the desired length of the hair to remain after the haircut.

Referring now to FIGS. 3A and 3B, a side view of each of clipper blade 210 and clipper blade 220 of FIG. 2 is shown. As shown in FIG. 3, each of clipper blade 210 and clipper blade 220 has a clipper blade thickness 310 or a clipper blade thickness 320, respectively.

Referring now to FIGS. 4A and 4B, a pair of combs in accordance with a preferred embodiment of the present invention is shown. Comb 410 comprises a solid handle portion 412, a plurality of teeth 411, a spine portion 413, and a brace portion 414. Comb 420 comprises a solid handle portion 422, a plurality of teeth 421, a spine portion 423, and a “fish-tail” or brace portion 424. Comb 410 and comb 420 are both substantially flat and one-dimensional. This is important because in at least some preferred embodiments of the present invention, comb 410 and comb 420 are packaged and sold as a kit, often with a plurality of additional items. The flat and one-dimensional nature of comb 410 and comb 420 will provide a slimmer profile, taking up less space during shipping and requiring less packaging and take up less space on a typical “peg” type display as is found in many retail outlets. Additionally, many hair stylists and hair cutting professionals travel from salon to salon and large, circular combs and brushes take up more space and, in at least some situations, are deemed less desirable.

As shown in FIG. 4A, comb 410 comprises a plurality of teeth 411 arranged in a single row and affixed to spine portion 413. While each tooth of single row of teeth 411 may vary slightly in size, each tooth is substantially the same shape.

As shown in FIG. 4B, comb 420 comprises a plurality of teeth 421 arranged in a single row and affixed to spine portion 423. While each tooth of single row of teeth 421 may vary slightly in size, each tooth is substantially the same shape.

Referring now to FIGS. 5A and 5B, a top view (e.g., looking down on the comb with the spine closest to the eye and the teeth being positioned beneath the spine) of each of comb 410 and comb 420 is shown. As shown in FIG. 5A and FIG. 5B, each of comb 410 and comb 420 has a spine thickness 510 or a spine thickness 520, respectively. As shown in FIGS. 5A and 5B, spine thickness 520 is greater than spine thickness 510. It should be noted that the each of combs 410 and 420 has a substantially uniform spine thickness over the length of spine portion 413 and 423 respectively and that spine thickness 510 and spine thickness 520 do not vary from the distal to the proximate end of their respective handles.

Additionally, as shown in FIG. 5A, each of the plurality of teeth are positioned in a single row that lies in substantially the same planar orientation relative to a longitudinal sectional line 517 taken along spine portion 413, hiding each of the plurality of teeth from observation since the width of each of the teeth is the same as the width of the thickness of spine portion 413.

Additionally, as shown in FIG. 5B, each of the plurality of teeth are positioned in a single row that lies in substantially the same planar orientation relative to a longitudinal sectional line 527 taken along spine portion 423, hiding each of the plurality of teeth from observation since the width of each of the teeth is the same as the width of the thickness of spine portion 423.

Referring now to FIGS. 4A and 4B and FIGS. 5A and 5B, the unique characteristics of the combs of the present invention can be more fully understood. While comb 410 and comb 420 are similar in some respects to other combs, the spine thickness 510 of spine portion 413 and spine thickness 520 of spine portion 423 have been specifically selected so as to correlate with blade thickness 310 and blade thickness 320, respectively.

In the most preferred embodiments of the present invention, the spine thickness 510 of comb 410 will be substantially identical to the thickness 310 of cutting blade 210. Similarly, the spine thickness 520 of comb 420 will be substantially identical to the thickness 320 of cutting blade 220.

In certain preferred embodiments of the present invention, comb 410 and comb 420, as well as other combs with varying spine thicknesses to match the spine thickness of a variety of clipper blades, are combined together with a plurality of clipper blades and may be sold as a unit, in a or other similar packaging arrangement. By selecting the appropriate comb, with a spine thickness that matches the thickness of the cutting blade, the hair stylists and barbers that are using comb 410 and comb 420 will automatically be using a comb that is designed to keep electric clippers closer to or further away from the head of the customer receiving the hair cut. The combs and the clipper blades may be color-coded to make the process of selecting the matching comb and clipper blade combination more efficient because the comb where the thickness of the spine portion of the comb matches the blade thickness of the desired clipper blade will be the same color.

Brace portion 424 consists of an enlarged section of handle portion 412 and is specifically configured to provide the hair stylist or barber with additional leverage for holding and positioning comb 410 or comb 420. It should be noted that since brace portion 424 is meant to provide leverage when the hair stylist or barber presses against brace portion 424, brace portion 424 is not a wire handle or a handle with an aperture formed in brace portion 424 that would limit the effectiveness of brace portion 424 to provide the desired leverage.

Those skilled in the art will recognize that by varying the thickness of the spine portion of a comb, the hair stylist or barber will be better equipped to keep electric clipper 110 of FIG. 1 in the proper position, relative to the head of the customer receiving the haircut. This is true for beginners as well as experienced hair stylists and barbers alike. The various embodiments of the present invention will assist hair stylists and barbers with the process of cutting hair to the appropriate length and will help to reduce or eliminate the possibility of cutting the hair too short.

Referring now to FIG. 6, a method 600 for using one or more combs of the present invention in providing a haircut is illustrated. As shown in FIG. 6, the hair stylist or barber will first ascertain the desired hair length (step 610). Next, the hair stylist or barber will select the appropriate cutting blade to use in cutting the hair to the desired length (step 620). With the appropriate cutting blade selected, the hair stylist or barber will select the matching comb (e.g., the comb that has a spine thickness that is substantially similar to the thickness of the selected cutting blade) (step 630). Finally, the hair stylist or barber will cut the hair using the selected combination of comb and cutting blade (step 640). It should be noted that the each of the possible matching combs has a substantially uniform spine thickness that does not vary from the distal to the proximate end of the spine portion of the handle.

It should also be noted that the hair stylist or barber may repeat the cycle with multiple matching combinations of cutting blades and combs for certain haircuts and other situations where the haircut involves cutting the hair in multiple different lengths. The process of selecting cutting blades and combs with matching thicknesses can be repeated as necessary until the haircut has been completed.

First the hair is cut on the sides & back of the head to the specified length using, for example, a #1.5 or #2 clipper blade, and on top of the head according to the guide length. In order to perform the above-described transition, a coordinating comb is chosen based on the requested length of the hair. Then, the comb is leaned with a slight pressure against the scalp and acts as a buffer between the hair and the blade. The hair is lifted with the comb in one hand and cut with the other hand, which is holding the electric clipper.

These combs offer a two-fold solution to the problem described above. First, because they have a spine thickness that corresponds to the size of the blade, the probability that the hair professional will cut more hair than desired is greatly reduced or eliminated. The thickness of the spine prevents the blade from going too far and cutting too much hair. Second, holding the comb while cutting the hair and leaning the comb gently against the customer's head provides significant hand support and greatly improves hand-eye coordination for both new and experienced barbers and hair stylists. The result is a new method of cutting hair and creating a smooth and mistake-free transition between two lengths of hair. The quality of the haircut, as well as barber's confidence and customer satisfaction, are greatly improved. Finally, the most preferred embodiments of the combs feature an ergonomically designed handle in the form of a “fish-tail” that ensures a firm grip on the handle and supports the palm of the hand. It fits well with any size hand, large or small.

While the examples set forth herein depict only a pair of combs, those skilled in the art will understand that is within the contemplated scope of this invention to include a plurality of combs (e.g., more than two), with the spine thickness of each of the combs corresponding to the thickness of a cutting blade. In this preferred embodiment of the present invention, no matter what cutting blade is selected, there will be a matching comb to be used with the selected cutting blade.

In another preferred embodiment of the present invention, an indicia representing the size of the cutting blade that corresponds to each of the combs is affixed to or printed on or embedded onto or into the handle of the appropriate comb. In this fashion, the hair stylist or barber can quickly and easily identify and select the appropriate comb, based on the selected cutting blade. In yet another preferred embodiment of the present invention, each matching set of comb and cutting blade may be provided with a color-based indicia or other similar marking. This will provide for the selection of a cutting blade and a corresponding comb by simply picking the matching colors.

In at least one preferred embodiment of the present invention, a set of two combs will be provided as a kit. The first comb will have a spine that is approximately 4.5 mm thick and the other comb will have a spine that is approximately 6 mm thick. These spine thicknesses corresponds to Oster® #1.5 clipper blade (˜4.5 mm or 5/32″) and Oster® #2 clipper blade (˜6 mm or ¼″) which are the most commonly used blades for shorter haircuts. The combs are used in performing the transition cut between two lengths of hair. The combs help the barber avoid cutting the hair too short at the transition point and provide additional hand support while cutting hair. These combs are especially useful for barbering or beauty students but also useful for experienced professionals.

From the foregoing description, it should be appreciated that an enhanced apparatus and methods for cutting hair is provided by the various preferred embodiments of the present invention and that the various preferred embodiments offer significant benefits that would be apparent to one skilled in the art. For example, those skilled in the art will understand that additional preferred embodiments of the combs and methods described herein could be readily adapted for use in pet grooming as well as other applications.

Furthermore, while multiple preferred embodiments have been presented in the foregoing description, it should be appreciated that a vast number of variations in the preferred embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

What is claimed is:

1. An apparatus comprising:
a first comb, the first comb comprising:
a first handle portion, the first handle comprising a first brace portion;
a first spine portion, the first spine portion defining a first spine thickness; and
a plurality of teeth affixed to the first spine portion, wherein each of the plurality of teeth are arranged in a row and wherein each of the plurality of teeth are positioned in substantially the same planar orientation relative to a longitudinal sectional line taken along the first spine portion, each of the plurality of teeth being of a substantially uniform shape and width; and
a first clipper blade, the first clipper blade defining a first blade thickness wherein the first blade thickness is substantially equal to the first spine thickness.

2. The apparatus of claim 1 wherein the first blade thickness and the spine thickness are substantially equal to 4.5 mm.

3. The apparatus of claim 1 wherein the first clipper blade is selected from a plurality of clipper blades, wherein the plurality of clipper blades comprises at least a clipper blade with a blade thickness substantially equal to 4.5 mm and at least a clipper blade with a blade thickness substantially equal to 6 mm.

4. The apparatus of claim 1 wherein the first blade thickness and the spine thickness are substantially equal to 6 mm.

5. The apparatus of claim 1 wherein the handle portion further comprises a fishtail shaped portion.

6. The apparatus of claim 1 wherein the first comb comprises a first comb color and wherein the first dipper blade comprises a first clipper blade color and wherein the first comb color and the first clipper blade color comprise the same color.

7. The apparatus of claim 1 further comprising:
a second comb, the second comb comprising:
a second handle portion, the second handle comprising a second brace portion;
a second spine portion, the second spine portion defining a second spine thickness; and
a plurality of teeth arranged in a single row, the plurality of teeth being affixed to the second spine portion, wherein each of the plurality of teeth are arranged in substantially the same planar orientation relative as a longitudinal sectional line taken along the second spine portion, the single row of teeth being of a substantially uniform shape and width; and
a second clipper blade, the second clipper blade defining a second blade thickness wherein the second blade thickness is substantially equal to the second spine thickness.

8. The apparatus of claim 7 wherein the first blade thickness and the first spine thickness of the first comb are substantially equal to 4.5 mm and wherein the second blade thickness and the second spine thickness of the second comb are substantially equal to 6 mm.

9. The apparatus of claim 7 wherein the first comb and the first blade are selected from a kit, the kit comprising:
a plurality of substantially flat combs, wherein each of the plurality of substantially flat combs comprises a spine thickness and wherein each of the plurality of combs comprises a different spine thickness; and
a plurality of clipper blades, wherein each of the plurality of clipper blades comprises a blade thickness and wherein each of the plurality of clipper blades comprises a different blade thickness.

10. The apparatus of claim 8 wherein each of the plurality of combs comprises a different color and wherein each of the plurality of clipper blades comprises a different color and wherein at least one of the plurality of combs and the plurality of dipper blades comprise the same color.

11. The apparatus of claim 7 wherein the first comb comprises a first comb color and wherein the first clipper blade comprises a first clipper blade color and wherein the first comb color and the first clipper blade color are the same color and wherein the second comb comprises a second comb color and wherein the second clipper blade comprises a second clipper blade color and wherein the second comb color and the second clipper blade color are the same color and wherein the first comb color and the second comb color are not the same color.

12. A method of cutting hair, the method comprising the steps of:
a) cutting a first portion of a client's hair to a first length;
b) cutting a second portion of a client's hair to a second length;
c) attaching a first clipper blade to an electric clipper, the first clipper blade comprising a plurality of cutting teeth and a first blade thickness;
d) selecting a first comb, the first comb comprising:
a first handle portion, the first handle comprising a first brace portion;
a first spine portion, the first spine portion defining a first spine thickness; and
a plurality of teeth affixed to the first spine portion, wherein each of the plurality of teeth are arranged in a row and wherein each of the plurality of teeth are positioned in substantially the same planar orientation relative to a longitudinal sectional line taken along the first spine portion, each of the plurality of teeth being of a substantially uniform shape and width, wherein the first blade thickness is substantially equal to the first spine thickness; and
e) creating a transition between the first length and the second length using the electric clipper and the first comb.

13. The method of claim 12 wherein the first blade thickness and the first spine thickness are substantially equal to 4.5 mm.

14. The method of claim 12 wherein the first blade thickness and the first spine thickness are substantially equal to 6 mm.

15. The method of claim 12 further comprising the steps of:
f) attaching a second clipper blade to the electric clipper, the second clipper blade comprising a plurality of cutting teeth and a second blade thickness; and
g) selecting a second comb, the second comb comprising:
a handle portion, the handle comprising a brace portion;
a spine portion, the spine portion defining a second spine thickness; and
a plurality of teeth affixed to the spine portion, wherein each of the plurality of teeth are arranged in a row and wherein each of the plurality of teeth are positioned in substantially the same planar orientation relative to a longitudinal sectional line taken along the spine portion, each of the plurality of teeth being of a substantially uniform shape and width, wherein the second blade thickness is substantially equal to the second spine thickness.

16. The method of claim 12 wherein steps c) and d) are performed prior to steps a) and b).

17. The method of claim 12 wherein the first brace portion comprises a fishtail portion.

18. The method of claim 17 wherein the second brace portion comprises a fishtail portion.

19. The method of claim 15 wherein the first comb comprises a first comb color and wherein the first clipper blade comprises a first clipper blade color and wherein the first comb color and the first clipper blade color are the same color and wherein the second comb comprises a second comb color and wherein the second clipper blade comprises a second clipper blade color and wherein the second comb color and the second clipper blade color are the same color and wherein the first comb color and the second comb color are not the same color.

20. A kit comprising:
a set of colored combs, the set of colored combs comprising a plurality of individual combs wherein each of the plurality of individual comb comprises a different color and wherein each of the plurality of individual combs comprises:
a handle portion, the handle comprising a brace portion;
a spine portion, the spine portion defining a first spine thickness; and
a plurality of teeth affixed to the spine portion, wherein each of the plurality of teeth are arranged in a row and wherein each of the plurality of teeth are positioned in substantially the same planar orientation relative to a longitudinal sectional line taken along the spine portion, each of the plurality of teeth being of a substantially uniform shape and width; and
a set of colored clipper blades, the set of color-coded clipper blades comprising a plurality of individual clipper blades wherein each of the plurality of individual clipper blades comprises a different color and wherein each of the plurality of individual clipper blades comprises a blade thickness, wherein the color of each of the plurality of individual clipper blades corresponds to the color of one of the plurality of individual combs and wherein the blade thickness of each of the plurality of individual clipper blades corresponds to the spine thickness of one and only one of the plurality of individual combs.
